(19) United States
(12) Patent Application Publication
(10) Pub. No.: US 2023/0237393 A1
(43) Pub. Date: Jul. 27, 2023

(54) PREDICTING FUTURE DEMAND USING TIME-SERIES FORECASTS

(71) Applicant: WORKDAY, INC., Pleasanton, CA (US)

(72) Inventors: Madhura RAUT, San Francisco, CA (US); David BOSWORTH, Phoenix, AZ (US)

(21) Appl. No.: 17/584,895

(22) Filed: Jan. 26, 2022

(51) Int. Cl. G06Q 10/06

(52) U.S. Cl. CPC G06Q 10/06311; G06Q 10/067

(57) ABSTRACT

The disclosure relates to predicting a demand based on a time-series prediction. In an embodiment, a method is disclosed which includes generating a predicted metric for a future time period; loading a plurality of rules, a given rule in the plurality of rules mapping an amount of the predicted metric to a demand amount; applying the plurality of rules to the predicted metric to compute a set of demand amounts; aggregating the set of demand amounts; and generating a predicted demand based on the aggregated demand amounts.

### BACKGROUND

The example embodiments are directed towards predictive modeling using machine learning (ML) and, in particular, predicting a labor demand based on forecasted time series data.

Currently, existing technical solutions to generate demand predictions (e.g., labor demand predictions) rely primarily on modeling the past behavior of such demand. For example, when predicting a labor demand, many current solutions utilize a predictive model that directly predicts a labor demand based on historical labor demands. Such solutions fail to provide flexibility when generating a demand prediction. Specifically, since such solutions are trained using past demand data, errors or missed demands tend to propagate during re-training of models. As a result, mismatched demands can be reinforced during training. Further, such models fail to account for the relationship between key metrics and demand (e.g., sales versus labor demand). Finally, users of such systems have little or no method for customizing the labor demand predictions, and such systems cannot account for individual requirements of organizations (e.g., labor laws, salary constraints, etc.). As a result, most demand prediction techniques fail to predict demands accurately.

### BRIEF DESCRIPTION OF THE DRAWINGS

FIG. 1 is a block diagram illustrating a system for predicting a labor demand according to some of the example embodiments.

FIG. 2 is a flow diagram illustrating a method for predicting a labor demand for a plurality of time slots according to some of the example embodiments.

FIG. 3 is a flow diagram illustrating a method for predicting a labor demand for a time slot according to some of the example embodiments.

FIG. 4 is a flow diagram illustrating a method for generating a role according to some of the example embodiments.

FIGS. 5A and 5B are screen diagrams of a graphical user interface (GUI) for displaying a labor forecast according to some of the example embodiments.

FIG. 6 is a screen diagram of a GUI for creating a rule according to some of the example embodiments.

FIGS. 7A and 7B are screen diagrams of a GUI for editing a rule according to some of the example embodiments.

FIG. 8 is a block diagram of a computing device according to some embodiments of the disclosure.

### DETAILED DESCRIPTION

The example embodiments remedy these and other technical problems in the art of predicting future demand using ML techniques by separating the concerns of time series prediction and demand prediction. Such a technique allows for more accurate demand prediction since the underlying demand prediction phase is not tightly coupled to the ML prediction phase. Specifically, the example embodiments provide a customizable demand pipeline where an initial time series prediction phase can use ML modeling to predict a future metric (e.g., sales). This output can then be fed into a labor demand phase which can apply organization-defined constraints to arrive at a customized demand prediction. The resulting demand prediction is thus both highly accurate (due to the use of independent metrics) and fully customizable (based on the use of organization-defined constraints).

The example embodiments provide techniques for predicting a demand (e.g., a labor or personnel demand) for a future time period. The embodiments receive predicted time-series data and load a set of constraints for a plurality of classifications (e.g., labor classifications). The embodiments apply these constraints to generate a set of interim predictions. The embodiments then aggregate these interim predictions for a given timeslot to generate a predicted demand.

In some aspects, the techniques described herein relate to a method including generating a predicted metric for a future time period; loading a plurality of rules, a given rule in the plurality of rules mapping an amount of the predicted metric to a demand amount; applying the plurality of rules to the predicted metric to compute a set of demand amounts; aggregating the set of demand amounts; and generating a predicted demand based on the aggregated demand amounts.

In some aspects, the techniques described herein relate to a method, wherein a given rule is associated with a labor classification, a given organization associated with at least one labor classification.

In some aspects, the techniques described herein relate to a method, wherein a given rule in the plurality of rules is associated with a plurality of constraints.

In some aspects, the techniques described herein relate to a method, wherein a given constraint in the plurality of constraints is associated with a range of amounts for the predicted metric and a demand.

In some aspects, the techniques described herein relate to a method, wherein a given constraint in the plurality of constraints is associated with a multiplier of the predicted metric and a demand.

In some aspects, the techniques described herein relate to a method, further including weighting each demand amount in the set of demand amounts prior to aggregating.

In some aspects, the techniques described herein relate to a method, wherein the future time period includes multiple timeslots and generating a predicted demand includes generating a plurality of corresponding demands for each timeslot in the multiple timeslots.

In some aspects, the techniques described herein relate to a device including: a processor; and a storage medium for tangibly storing thereon program logic for execution by the processor, the program logic including: logic, executed by the processor, for generating a predicted metric for a future time period; logic, executed by the processor, for loading a plurality of rules, a given rule in the plurality of rules mapping an amount of the predicted metric to a demand amount; logic, executed by the processor, for applying the plurality of rules to the predicted metric to compute a set of demand amounts; logic, executed by the processor, for aggregating the set of demand amounts; and logic, executed by the processor, for generating a predicted demand based on the aggregated demand amounts.

In some aspects, the techniques described herein relate to a device, wherein a given rule is associated with a labor classification, a given organization associated with at least one labor classification.

In some aspects, the techniques described herein relate to a device, wherein a given rule in the plurality of rules is associated with a plurality of constraints.

In some aspects, the techniques described herein relate to a device, wherein a given constraint in the plurality of constraints is associated with a range of amounts for the predicted metric and a demand.

In some aspects, the techniques described herein relate to a device, wherein a given constraint in the plurality of constraints is associated with a multiplier of the predicted metric and a demand.

In some aspects, the techniques described herein relate to a device, the program logic further including logic, executed by the processor, for weighting each demand amount in the set of demand amounts prior to aggregating.

In some aspects, the techniques described herein relate to a device, wherein the future time period includes multiple timeslots and generating a predicted demand includes generating a plurality of corresponding demands for each timeslot in the multiple timeslots.

In some aspects, the techniques described herein relate to a non-transitory computer-readable storage medium for tangibly storing computer program instructions capable of being executed by a computer processor, the computer program instructions defining steps of: generating a predicted metric for a future time period; loading a plurality of rules, a given rule in the plurality of rules mapping an amount of the predicted metric to a demand amount; applying the plurality of rules to the predicted metric to compute a set of demand amounts; aggregating the set of demand amounts; and generating a predicted demand based on the aggregated demand amounts.

In some aspects, the techniques described herein relate to a non-transitory computer-readable storage medium, wherein a given rule in the plurality of rules is associated with a plurality of constraints.

In some aspects, the techniques described herein relate to a non-transitory computer-readable storage medium, wherein a given constraint in the plurality of constraints is associated with a range of amounts for the predicted metric and a demand.

In some aspects, the techniques described herein relate to a non-transitory computer-readable storage medium, wherein a given constraint in the plurality of constraints is associated with a multiplier of the predicted metric and a demand.

In some aspects, the techniques described herein relate to a non-transitory computer-readable storage medium, further including weighting each demand amount in the set of demand amounts prior to aggregating.

In some aspects, the techniques described herein relate to a non-transitory computer-readable storage medium, wherein the future time period includes multiple timeslots and generating a predicted demand includes generating a plurality of corresponding demands for each timeslot in the multiple timeslots.

In other embodiments, devices, systems, and non-transitory computer-readable media are described for performing these and other methods.

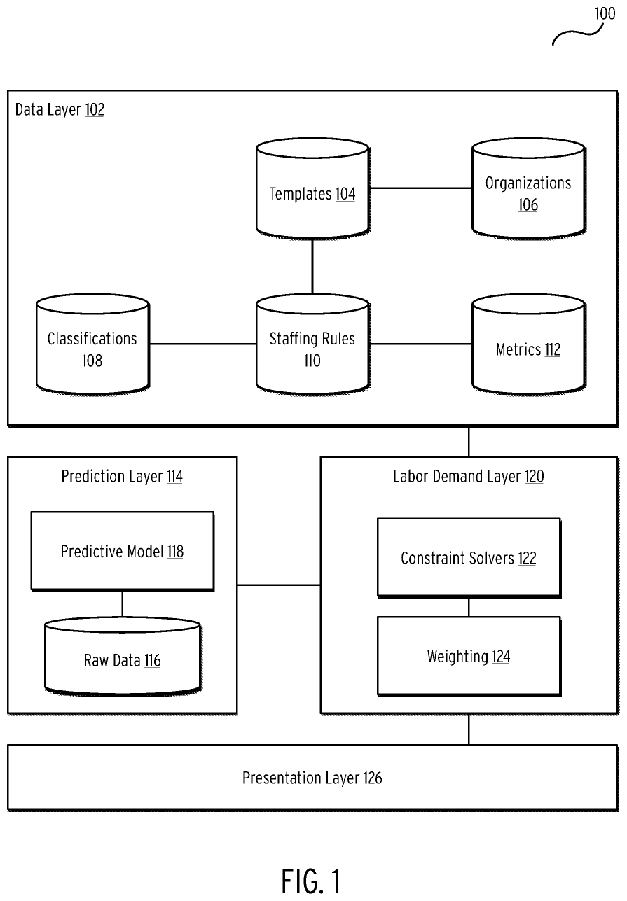

FIG. 1 is a block diagram illustrating a system 100 for predicting a labor demand according to some of the example embodiments.

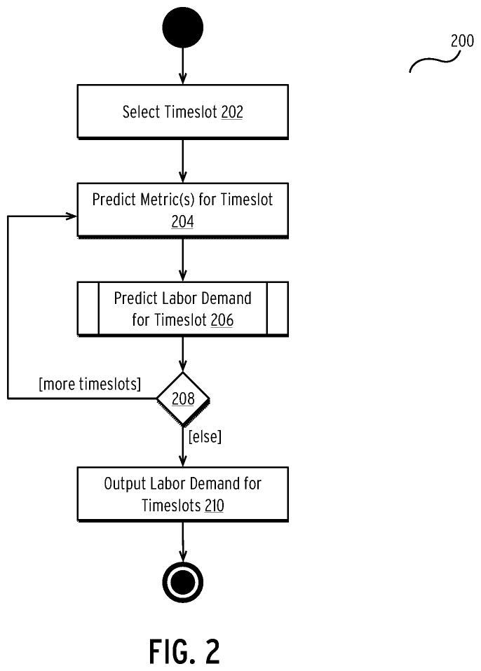

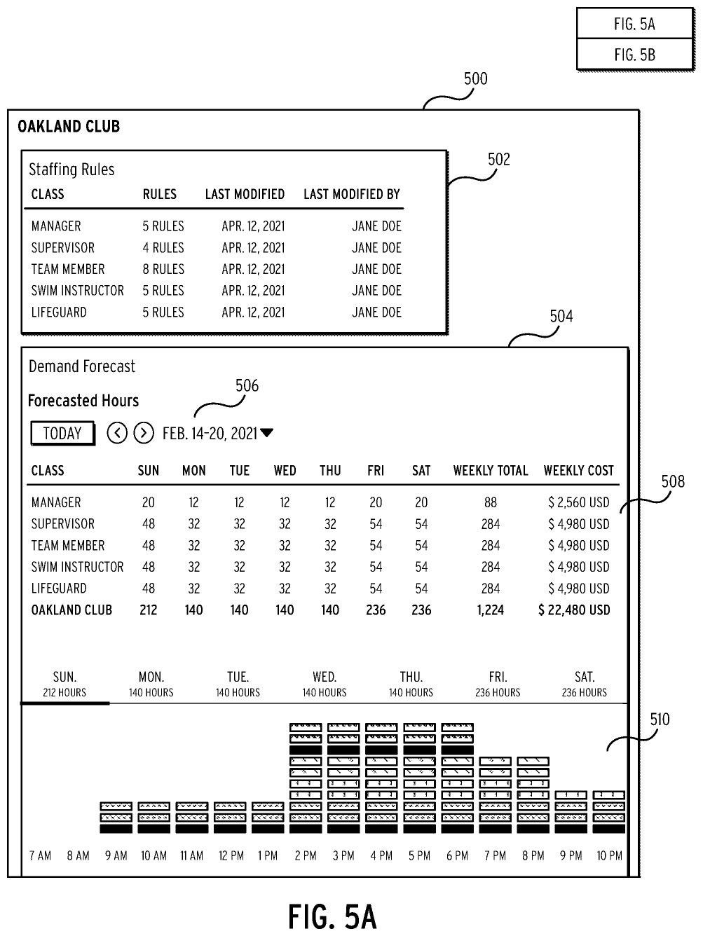

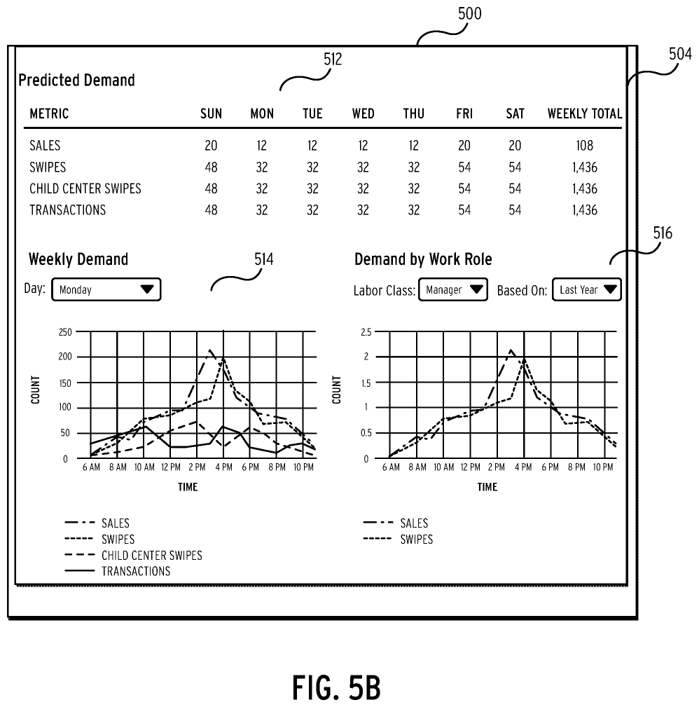

In an embodiment, system 100 includes a data layer 102, prediction layer 114, labor demand layer 120, and a presentation layer 126. These layers coordinate to perform the operations described in connection with FIGS. 2 through 4 and provide interfaces such as those depicted in FIGS. 5 through 7, the descriptions of which are not repeated herein.

In an embodiment, the data layer 102 can include a plurality of databases storing data used to generate demand predictions. In an embodiment, the data layer 102 can include an organizations database 106. In an embodiment, organizations database 106 stores details regarding organizations using the system. In some embodiments, an organization can comprise a company, a division of a company, a location operated by a company, etc. In some embodiments, the organizations database 106 can comprise a set of tables storing various details regarding organizations such as physical or virtual locations of the organization.

In an embodiment, the data layer 102 can include a templates database 104. In an embodiment, the templates database 104 can store a set of pre-configured templates that can be created by and/or mapped to organizations stored in organizations database 106. In some embodiments, a given template in templates database 104 can be associated with one or more labor classifications (stored in classifications database 108) and one or more rules (stored in the rules database 110). In some embodiments, templates stored in templates database 104 can be used to quickly add a set of preconfigured labor classifications and rules to a new organization or division of an organization.

In an embodiment, classifications database 108 stores a set of labor classifications. As used herein, a labor classification can include a role type such as a job position at a store. For example, a labor classification can include a “manager” role, a “trainer” role (for a gym), a “sales associate” role (for a retailer), etc. The specific types of roles are not limiting, and more roles can be defined.

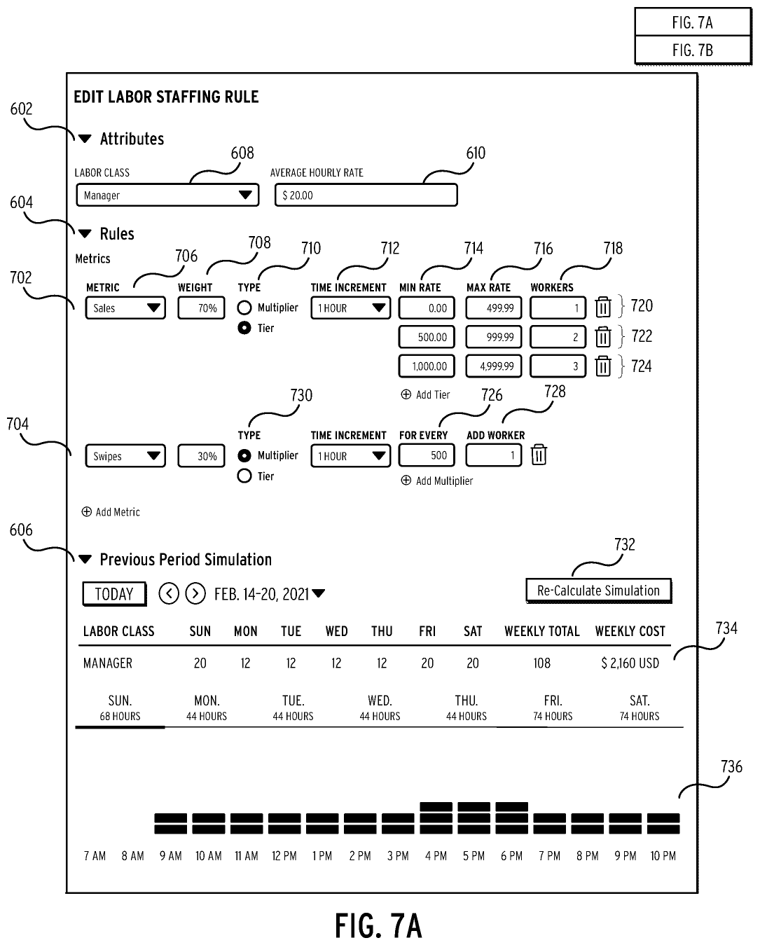

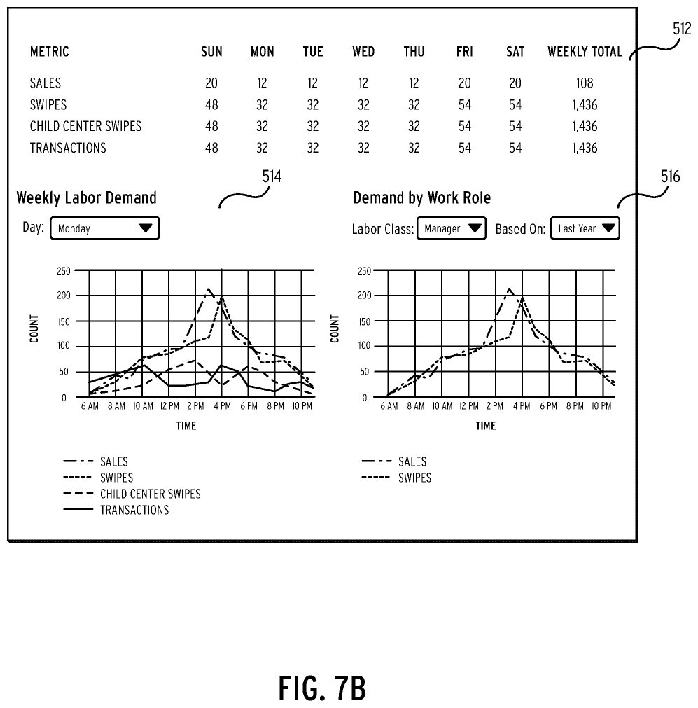

In an embodiment, rules database 110 stores a set of rules that can be applied to labor classifications stored in classifications database 108. In an embodiment, each labor classification includes a set of one or more rules. In some embodiments, each rule includes at least one constraint applied to a metric. In some embodiments, such metrics are stored in metrics database 112. In some embodiments, a given rule for a labor classification can map a metric to a labor demand based on the constraints. In some embodiments, the mapping to labor demand can include a mapping to a number of required persons that can fulfill the labor classification. FIGS. 7A and 7B provide examples of such rules for a “manager” labor classification of the “Oakland Club” organization. As one example, a first rule includes three constraints mapping a predicted sales metric to a number of managers. Thus, when sales are between $0.00 and $499.99 (the first constraint), the rule maps to one manager; when sales are between $500.00 and $999.99 (the second constraint), the rule maps to two managers; etc.

In an embodiment, the metrics database 112 stores a set of metrics. In some embodiments, a metric can be represented by a name (e.g., “Sales”), type (e.g., numeric), a time increment, a data source (e.g., a source in which the data is captured), and a free-form description. In some embodiments, the time increment can be used as a timeslot in determining a labor demand. In some embodiments, the time increment maps one-to-one with the length of a timeslot. In other embodiments, the time increment may be longer or shorter than the timeslot.

Although the foregoing description of data layer 102 describes various types of data being stored in independent databases, the disclosure is not limited as such. For example, some databases can be combined. Further, in some embodiments, an organization can be represented in a document-oriented datastore, and all data in the various databases can be encapsulated in a single document for the organization. Thus, the specific architecture illustrated is not intended to be limiting.

In the illustrated embodiment, a prediction layer 114 generates future predictions used by labor demand layer 120 to generate demand predictions. In an embodiment, a predictive model 118 forecasts a time series value of the metric based on raw data 116. In some embodiments, raw data 116 can comprise data recorded by an organization (e.g., stored in organizations database 106) during the course of operations. As one example, predictive model 118 can use a stacking ensemble model to predict a metric for the selected timeslot based on raw data 116. In an embodiment, the stacking ensemble model can include a decision tree-based classifier (e.g., a LightGBM model) and a recurrent neural network (RNN). In an embodiment, the outputs of the classifier and RNN are blended with a meta-learner (e.g., a linear regression) to predict a metric for the selected timeslot. In some embodiments, the predictive model can include a single-step forecasting model, and only the next timeslot closest to the current timeslot can be predicted. In other embodiments, the predictive model can include a multi-step predictive model and can predict multiple future timeslots (including the selected timeslot). Further detail on predicting metrics for timeslots is provided in commonly-owned application bearing Attorney Docket No. 166310-800050. While the foregoing example is one technique for predicting a metric for a timeslot occurring in the future, any technique for predicting a future metric can be used. The specific example, and the examples in commonly-owned application bearing Attorney Docket No. 166310-800050, are used only as examples are non-limiting.

The labor demand layer 120 can receive predictions from prediction layer 114 and generate a demand prediction for each prediction. As discussed, in some embodiments, the prediction can comprise a single timeslot or multiple timeslots. In brief, a set of constraint solvers 122 apply rules and constraints forming the rules to the predicted metric to generate a set of predictions. A weighting component 124 then aggregates this set of predictions to generate a final predicted demand for a given predicted metric. Various details of the operations of labor demand layer 120 are described more fully in FIGS. 2 through 4 and are not repeated herein.

Once the labor demand layer 120 generates one or more demand predictions, a presentation layer 126 packages the predictions in a presentable format. In some embodiments, presentation layer 126 can provide programmatic access to the predictions via an expose network endpoint (e.g., a Representational State Transfer, REST, endpoint) that provides access to the data. In such an embodiment, a mobile application or webpage can retrieve the data and generate a user interface (such as those depicted in FIGS. 5 through 7). Alternatively, or in conjunction with the foregoing, presentation layer 126 can generate a webpage or similar document that presents a user interface (such as those depicted in FIGS. 5 through 7).

FIG. 2 is a flow diagram illustrating a method 200 for predicting a labor demand for a plurality of time slots according to some of the example embodiments.

In step 202, method 200 can include selecting a timeslot.

In the various embodiments, a timeslot can include a fixed duration. In an embodiment, timeslots include periods of time occurring after a fixed time. In some embodiments, the fixed time can include the current timeslot. In other embodiments, the timeslot can include a past or future timeslot relative to the current timeslot. In some embodiments, the fixed duration can be of varying granularity (e.g., thirty minutes, one hour, one day, one week, etc.), and the disclosure is not limited to a specific duration.

In the embodiments, method 200 selects a timeslot from a time horizon. In some embodiments, the time horizon can be a sequence of timeslots occurring a fixed amount of time from a current timeslot. For example, if the current timeslot is 00:00-01:00, the timeslot duration is one hour, and the time horizon is one day, the time horizon can include twenty-three timeslots evenly distributed between 01:00 and 23:59. Certainly, if the current timeslot is shifted, the same 24-hour time horizon is shifted accordingly. Specific numerical values or times are not limiting.

In step 204, method 200 can include predicting a metric for the selected timeslot.

In some embodiments, step 204 can include predicting one or more metrics for the selected timeslot. The specific metrics may be chosen based on the needs of the system, and specific metric types are not limiting. As one example used throughout, the metrics can include a number of predicted sales for the timeslot (in currency) and/or the number of membership card swipes (as an integer). As illustrated, method 200 can predict one or more metrics, and the disclosure is not limited to a certain number of metrics.

In some embodiments, method 200 can use a predictive model to predict one or more metrics. In one embodiment, the predictive model forecasts a time series value of the metric based on historical data. As one example, method 200 can use a stacking ensemble model to predict a metric for the selected timeslot. In an embodiment, the stacking ensemble model can include a decision tree-based classifier (e.g., a LightGBM model) and an RNN. In an embodiment, the outputs of the classifier and RNN are blended with a meta-learner (e.g., a linear regression) to predict a metric for the selected timeslot. In some embodiments, the predictive model can include a single-step forecasting model, and only the next timeslot closest to the current timeslot can be predicted. In other embodiments, the predictive model can include a multi-step predictive model and can predict multiple future timeslots (including the selected timeslot). Further detail on predicting metrics for timeslots is provided in commonly-owned application bearing Attorney Docket No. 166310-800050. While the foregoing example is one method for predicting a metric for a timeslot occurring in the future, any technique for predicting a future metric can be used. The specific example, and the examples in commonly-owned application bearing Attorney Docket No. 166310-800050, are used only as examples are non-limiting.

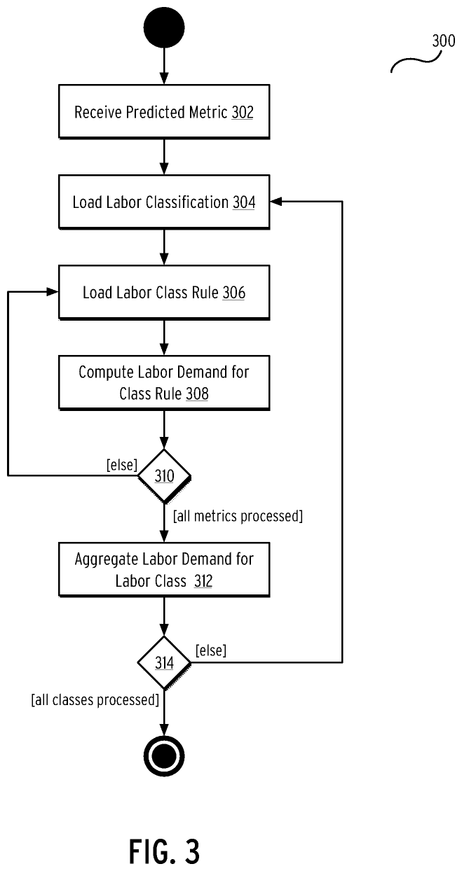

In step 206, method 200 can include predicting a labor demand for the selected timeslot based on one or more predicted metrics. Detail of step 206 is provided in the description of FIG. 3, which is not repeated herein. In brief, method 200 can load one or more roles and load a plurality of class rules for the roles to compute a predicted labor demand. Then, the individual demands for a given role can be aggregated to generate a predicted labor demand for a given role. This process can then be repeated for all desired roles. In some embodiments, step 206 can be executed for each type of metric. In some embodiments, method 200 can perform step 206 for each metric in parallel (e.g., in separate threads).

In step 208, method 200 can include determining if any more timeslots remain. As described above, method 200 can determine if all timeslots in a time horizon have been processed. In an embodiment, method 200 iterates through each timeslot in temporal order from a current timeslot. Thus, method 200 executes steps 204 and 206 for each timeslot in the time horizon. In an embodiment, step 204 can optionally only be executed once. In such an embodiment, step 204 can include a multi-step predictive model). In such an embodiment, method 200 can only execute step 206 for each timeslot, using the multi-step predicted metric values as inputs. Once method 200 generates a labor demand for each timeslot, method 200 can proceed to step 210.

In step 210, method 200 can include outputting a labor demand forecast for the selected timeslots. In some embodiments, method 200 can include generating a webpage or similar GUI for displaying the labor demand forecast. Alternatively, or in conjunction with the foregoing, method 200 can include transmitting the underlying labor demand forecast data for client-side assembly of a GUI. In an embodiment, the client can include a mobile application accessing the outputted labor demand forecast by calling an application programming interface (API). One example of a GUI is provided in FIGS. 5A and 5B, and that description is not repeated herein.

In some embodiments, method 200 can be executed for a given entity. In some embodiments, an entity can include a store location. In some embodiments, the store location can be operated by a store operator. Thus, in some embodiments, a store operator can execute method 200 for the store location to generate a labor demand forecast for the store location. Certainly, method 200 can be re-executed for other store locations or can be executed by other operators for even further store locations. Although stores are described, other types of organizations employing staff (paid or unpaid) can be used in place of stores.

Although the foregoing examples describe predicting a labor demand, any type of demand related to the predicted metric or the underlying organization can be used. For example, an equipment demand can be predicted based on a predicted metric (e.g., sales). As another example, a feed demand can be predicted based on a predicted livestock value. The disclosure should be limited as such only to labor demand prediction and indeed can be used to predict any related demand.

FIG. 3 is a flow diagram illustrating a method 300 for predicting a labor demand for a time slot according to some of the example embodiments.

In step 302, method 300 can include receiving a predicted metric.

As discussed above in the description of FIG. 2, method 300 can be executed for a selected timeslot and for a given metric (e.g., sales or swipes). As described in step 204, the predicted metric can be generated for a selected (i.e., future) timeslot. As illustrated in step 206, step 302 can be executed for each timeslot in a time horizon.

In step 304, method 300 can include loading a labor classification.

As used herein, a labor classification can include a role type such as a job position at a store. For example, a labor classification can include a “manager” role, a “trainer” role (for a gym), a “sales associate” role (for a retailer), etc. The specific types of roles are not limiting, and more roles can be defined.

In an embodiment, an operator of method 300 (and method 200) can define a plurality of organizations. An organization can be a company, non-profit, or similar owner and/or operator of locations that employ staff. FIGS. 5A and 5B illustrate an organization having the name “Oakland Club” that includes, for example, an aquatics center or private pool. In some embodiments, the organization can be a division of a location (e.g., a pool located within a health club), and the disclosure does not limit organizations as such.

In some embodiments, an organization can be associated with a template. In some embodiments, a template can be a set of labor classifications. That is, a given location can be associated with a variety of staff types. Returning to FIGS. 5A and 5B, the “Oakland Club” organization is associated with five labor classifications: manager, supervisor, team member, swim instructor, and lifeguard. Each labor classification can be a role that may be fulfilled by one or more individuals.

Thus, method 300 can load all assigned labor classifications for a given organization that method 300 can execute based on a predefined template for the organization. Then, in step 304, method 300 can load a first labor classification and, as will be discussed, loads each remaining labor classification until all labor classifications have been loaded.

In step 306, method 300 can include loading a labor class rule for a given labor classification.

In an embodiment, each labor classification includes a set of one or more rules. In some embodiments, each rule includes at least one constraint applied to a predicted metric. In some embodiments, a given rule for a labor classification can map a predicted metric to a labor demand based on the constraints. In some embodiments, the mapping to labor demand can include a mapping to a number of required persons that can fulfill the labor classification. FIGS. 7A and 7B provide examples of such rules for a “manager” labor classification of the “Oakland Club” organization. As one example, a first rule includes three constraints mapping a predicted sales metric to a number of managers. Thus, when sales are between $0.00 and $499.99 (the first constraint), the rule maps to one manager; when sales are between $500.00 and $999.99 (the second constraint), the rule maps to two managers; etc.

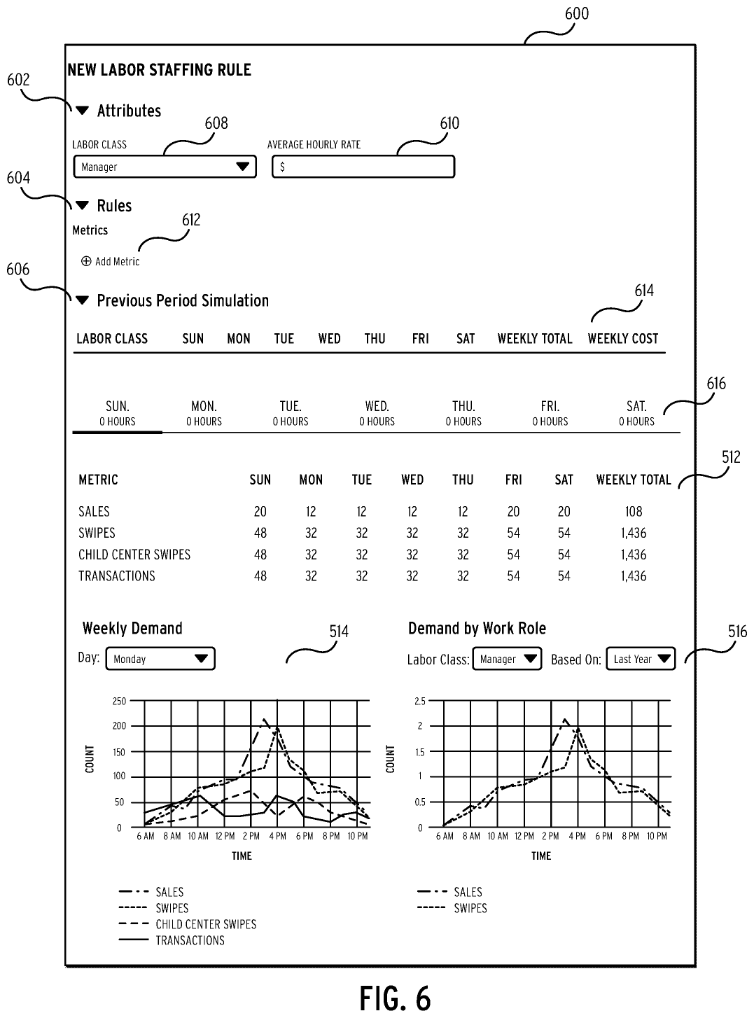

In some embodiments, the constraints (and thus rules) can be defined by an operator of an organization. As illustrated in FIGS. 6 and 7, operators can manually add new rules. In some embodiments, rules can be predicted based on past performance. In some embodiments, a GUI can present a simulation output that allows the operator to see how the rules would be applied to generate a labor demand for the next time horizon. In this way, operators can dynamically adjust the constraints and rules to determine how to best allocate their workforce. Thus, if the first attempt at defining constraints results in (for example) more workers predicted than the organization employs, the operator can adjust the rule to capture this implicit constraint.

In step 308, method 300 can include computing a labor demand for the labor class rule.

In some embodiments, step 308 can include matching the predicted metric with the corresponding constraint and using the mapped labor demand as the computed labor demand. For example, continuing the example depicted in FIGS. 7A and 7B, if the predicted sales volume is $700.00, method 300 matches the constraint that captures this value ($500.00-$999.99) and uses the mapped labor demand (two managers) as the labor demand for the labor class rule.

In some embodiments, step 308 can further comprise weighting the mapped labor demand based on a weight associated with the rule. As illustrated in FIGS. 7A and 7B, the sales labor rule is assigned a weight of 70%. In some embodiments, this weight can be manually entered and adjusted by the operator during setup. Thus, in some embodiments, method 300 retrieves the mapped labor demand (two managers) and weights the mapped labor demand by the weight to obtain a weighted labor demand (1.4 managers). Although FIGS. 7A and 7B illustrate a single labor class rule for a metric (“sales”), multiple such rules can be assigned to a single metric.

In step 310, method 300 can determine if all metrics for the labor classification were processed. As described, a given labor classification can include multiple rules, and these rules can be associated with multiple metrics (e.g., sales and swipes). Thus, in step 310, method 300 determines if all rules for a given metric were run and then determines if further metrics need processing. If so, method 300 loads the next set of one or more rules for the next metric (e.g., swipes) in step 306 and executes step 308 again to compute the weighted labor demand for the labor classification. For example, as illustrated in FIGS. 7A and 7B, if the next metric (swipes) is predicted as 250, method 300 will compute a mapped labor demand (one manger) and then weight the mapped labor demand by the weight (30%) to obtain a weighted labor demand of 0.3 managers for the swipe metric. In an alternative embodiment, method 300 can forego weighting the mapped labor demand in step 308 and perform the weighting in step 312. Once method 300 has processed all metrics and all rules for each metric, method 300 proceeds to step 312.

In step 312, method 300 can aggregate labor demand for the labor class.

According to the foregoing steps, method 300 computes various weighted labor demands for a given labor classification. These weighted labor demands can correspond to the predicted metrics. In some embodiments, method 300 can aggregate these weighted labor demands by performing a summation of the weighted labor demands. Continuing the previous example, method 300 can sum the 1.4 managers (based on sales) with the 0.3 managers (based on swipes) to generate a labor demand 0 f 1.7 managers. In some embodiments, method 300 can round the labor demand to obtain an integer value. In an embodiment, method 300 can compute the ceiling of the summation (e.g., two managers in the example) or can compute the floor (e.g., one manager in the example). In some embodiments, the labor demand computed in the foregoing steps can be represented as:

$${d}_{i} = round ( {\sum }_{j = 0}^{n} {\sum }_{k = 0}^{m} {c}_{j , k} {w}_{k} ) \qquad EQUATION 1$$

In Equation 1, dᵢ (p) represents the aggregated labor demand for an i-th labor classification. An outer sum aggregates labor demands for a set of n metrics while the inner sum computes the labor demand of m rules associated with a given metric. As illustrated, c_{j,k} represents the labor mapping for a k-th rule of a j-th metric and wₖ represents a weight for a given rule. Further, round comprises a ceiling, floor, or similar function. Often, the value of m will be one, however, the disclosure is not limited as such. In such a case, Equation 1 can be simplified as:

$${d}_{i} = round ( {\sum }_{j = 0}^{n} {c}_{j} {w}_{j} ) \qquad EQUATION 2$$

In Equation 2, c₁ represents the value of the constraint for a j-th rule of a labor classification and wⱼ represents the weight of the j-th rule.

In step 314, method 300 determines if any labor classifications remain to be processed. As discussed, method 300 can be re-executed to generate a labor demand forecast for each labor classification defined for a given organization. Thus, method 300 will determine in step 314 if any labor classifications haven't been processed and will re-execute the foregoing process for each remaining labor classification.

In the illustrated embodiment, the output of method 300 comprises a set of labor demands for each labor classification and for a single timeslot. Thus, method 300 can generate an m-dimensional vector, m corresponding to each unique labor classification. Using method 200, method 300 can be re-executed for each future timeslot in a time horizon, thus generating an m×n matrix, n representing the number of future timeslots in chronological order.

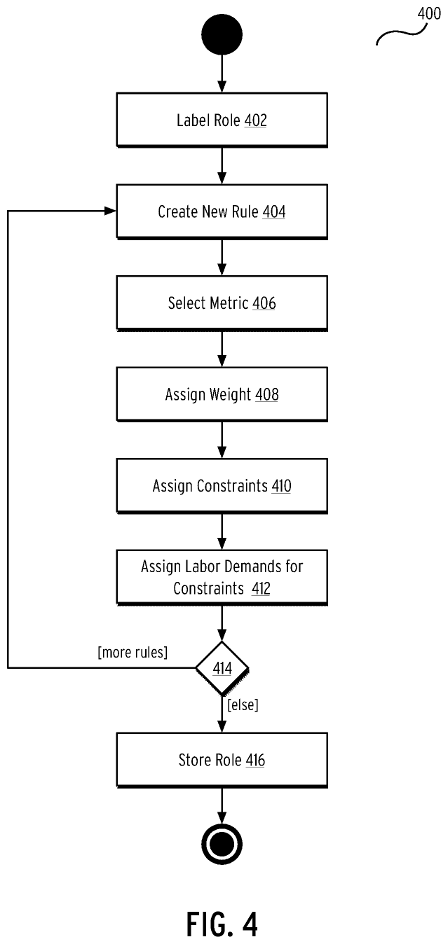

FIG. 4 is a flow diagram illustrating a method 400 for generating a role according to some of the example embodiments.

In step 402, method 400 can include labeling a role. In an embodiment, method 400 can be executed via a webpage, mobile application, or another type of GUI. In an embodiment, the GUI can include the GUI depicted in FIG. 6 or 7. In step 402, method 400 can provide an entry field for assigning a label to the role. In some embodiments, the label can comprise a job title or similar text field.

In step 404, method 400 can include creating a new rule.

In some embodiments, upon creation (e.g., labeling) of a new role, the new role is associated with an empty rule set (e.g., zero rules). Thus, in step 404, method 400 can include adding a first rule (and subsequent rules). In some embodiments, method 400 initializes an empty rule pending rule parameters (e.g., constraints, weights, etc.) as described below.

In step 406, method 400 can include selecting a metric. In some embodiments, method 400 can present a set of pre-configured metrics (e.g., sales, swipes, etc.) that are defined by a system operator. In some embodiments, the metrics can be presented in, for example, a dropdown menu or a similar menu. In some embodiments, a metric can be represented by a name (e.g., “Sales”), type (e.g., numeric), a time increment, a data source (e.g., a source in which the data is captured), and a free-form description. In some embodiments, the time increment is used as a timeslot in determining a labor demand. In some embodiments, the time increment maps one-to-one with the length of a timeslot (in FIGS. 2 and 3). In other embodiments, the time increment may be longer or shorter than the timeslot.

In step 408, method 400 can include assigning a weight to the rule.

In an embodiment, method 400 can provide an input field (e.g., dropdown, slider, input field), allowing a user to assign a weight to the rule. In some embodiments, the weight comprises a value between zero and one. In some embodiments, the weight can be represented as a percentage. In some embodiments, method 400 can enforce that the sum of all weights defined using method 400 equals one.

In an optional embodiment, method 400 can further prompt the user for a type of rule prior to proceeding to step 410. In one embodiment, method 400 can use the type of rule to determine the GUI to display for implementing step 410 and step 412. Examples of types include a tier type, where constraints can be represented as ranges, and a multiplier type, where constraints define multipliers that trigger labor demand changes. Both types are illustrated in FIGS. 7A and 7B, and that description is not repeated herein.

In step 410, method 400 can include assigning one or more constraints to the rule.

As described above, a constraint maps a metric value or range of values to a mapped labor demand. In a tier type, a constraint defines a minimum metric value and maximum value. When the predicted metric value falls within the minimum and maximum, the constraint is met. In some embodiments, method 400 can check that multiple constraints do not overlap for a tier rule. In some embodiments, method 400 can check that multiple constraints are continuous in a tier rule. In an increment type, the constraint can be represented as a multiplier value. A multiplier value can then be used to determine how many multiples of the multiplier are in the predicted metric value. Thus, the predicted metric value (p) can be divided by the multiplier (m) to obtain a number of multipliers (n) which can then be multiplied by the mapped labor demand to obtain the final mapped labor demand.

Other types of constraints may be used, and the disclosure is not limited only to these two types of constraints.

In step 412, method 400 can include assigning a mapped labor demand for the constraints.

In an embodiment, method 400 can provide a GUI for allowing an operator to assign a mapped labor demand for each constraint. For a tier type, the mapped labor demand can comprise the actual mapped labor demand used in later calculations (described in FIG. 3). In a multiplier type, a supplemental operation (described above as n=p/m) can be used to calculate the actual mapped labor demand (described in FIG. 3 as well). In some embodiments, method 400 can provide an input field (e.g., dropdown, slider, input field), allowing a user to enter a labor demand for each constraint.

In step 414, method 400 can include determining if any more rules are to be added. In some embodiments, method 400 can continue for an arbitrary number of rules added for a given role. Thus, in some embodiments, method 400 can branch to step 404 until an operator has created all desired rules.

In step 416, method 400 can include storing the rules for the role. In some embodiments, method 400 can serialize all the data entered by the user into a serialized format (e.g., JavaScript Object Notation) and transmit the serialized role to a server for persistent storage. These roles can then be applied to organizations and used for predicting labor demand as described previously.

FIGS. 5A and 5B are screen diagrams of a graphical user interface (GUI) for displaying a labor forecast according to some of the example embodiments.

Screen diagram 500 depicts an organization-level interface for managing a demand forecast of an organization or location. In the illustrated embodiment, a location (“Oakland Club”) is used as an example of an aquatics center.

In the illustrated embodiment, screen diagram 500 includes a staffing rules panel 502. In an embodiment, the staffing rules panel 502 displays the types of staff (e.g., manager, supervisor, team member, swim instructor, lifeguard) that are employed at the location. Additionally, the staffing rules panel 502 displays how many rules are attached to each type of role. Notably, the staffing rules panel 502 does not indicate how many of each time of staff are employed or required, as will be discussed. In some embodiments, a user can select a given classification displayed in staffing rules panel 502 to edit the rules for a given classification. An example of a GUI for editing such a rule is depicted in FIGS. 7A and 7B. In some embodiments, staffing rules panel 502 can include a control (e.g., hyperlink or button) to add new rules or, as depicted in the GUI of FIG. 6.

The screen diagram 500 further includes a demand forecast panel 504. In an embodiment, the demand forecast panel 504 includes various UI elements for displaying a demand forecast. In an embodiment, demand forecast panel 504 can include a set of controls 506 that allow a user to change a forecasting period (e.g., a given week). When a user selects a new forecasting period, the screen diagram 500 can be updated (and, in particular, demand forecast panel 504 can be updated) to display a forecast for the given period.

The demand forecast panel 504 includes a cost panel 508 which depicts the predicted demand forecast as well as a corresponding cost. In the illustrated embodiment, for each role, a daily demand total (Sunday through Saturday) is presented. Corresponding daily totals and weekly totals are also provided. In the illustrated embodiment, cost panel 508 depicts the number of predicted labor hours per day, but the disclosure is not limited as such. In addition to labor demands, the cost panel 508 can display a weekly cost associated with the predicted labor. In an embodiment, the weekly cost can be computed by multiplying an hourly wage (as depicted in FIGS. 6 and 7) by the predicted hourly demand.

The demand forecast panel 504 can further include an hourly demand panel 510. In an embodiment, the hourly demand panel 510 can include a control for each day of the week to allow users to view a demand over time for a given day. As illustrated, for each hour of a working day (as defined by the organization), a chart illustrating the number of hours per labor classification can be presented to visualize the labor demand over time. Although an hour timeslot duration is used, other durations may be used.

The demand forecast panel 504 can further include a predicted demand panel 512. In an embodiment, the predicted demand panel 512 can present the predicted metrics for future timeslots. In some embodiments, the data used in predicted demand panel 512 can comprise the output of the predictive model used in step 302. In some embodiments, the GUI can aggregate timeslots to provide higher-level data. For example, hourly metric predictions can be aggregated to generate daily predictions, as illustrated in predicted demand panel 512. As illustrated, multiple metrics (e.g., sales, swipes, child center swipes, transactions, etc.) can be presented.

Finally, the demand forecast panel 504 can include various graphs to visualize demand data. In an embodiment, a weekly demand graph 514 can plot the average daily metric volume for a given time period (e.g., daily). As illustrated, various metrics (e.g., sales, swipes, child center swipes, transactions) can be aggregated for selected data (e.g., Monday), and the per-timeslot averages can be plotted over the course of the day. Similarly, work role demand graph 516 can plot a historical mapping of work role allocations (e.g., the number of employees) over time for a given reporting period (e.g., one year). As illustrated, the various graphs illustrate the work role demand for each individual metric (in isolation) over time.

FIG. 6 is a screen diagram 600 of a GUI for creating a rule according to some of the example embodiments.

In an embodiment, screen diagram 600 allows a user to create a new rule for a given labor classification. In an embodiment, screen diagram 600 includes an attributes panel 602 that allows users to select a labor classification via select box 608 and enter an hourly rate via text field 610. As discussed, a given organization can create labor classifications for a plurality of locations. As such, screen diagram 600 allows a user to select one of these pre-configured labor classifications via select box 608. Next, a user can enter an hourly rate for the user via text field 610. As discussed, the hourly rate can be used to present an estimated cost of labor in cost panel 508.

The screen diagram 600 further includes a rules panel 604. In an embodiment, the rules panel 604 allows users to add new rules for a given labor classification. Thus, by selecting the “New Metric” button in rules panel 604, screen diagram 600 allows a user to add new rules for a given metric. Details of adding new rules for metrics are provided in the description of FIGS. 7A and 7B.

The screen diagram 600 further includes a previous period simulation panel 606. In an embodiment, the previous period simulation panel 606 allows the user to simulate the entered rules on a previous period. The previous period simulation panel 606 includes a cost panel 614 and hourly demand panel 616, which are similar to cost panel 508 and hourly demand panel 510 and are not repeated herein. However, the cost panel 614 and hourly demand panel 616 are blank in screen diagram 600 since the user has not entered any rules. FIGS. 7A and 7B provide an example of such panels having data after entering a rule.

Finally, screen diagram 600 can include a predicted demand panel 512, weekly demand graph 514, and work role demand graph 516. These panels are similar or identical to those discussed in FIGS. 5A and 5B and are not described again in detail herein.

FIG. 7 are screen diagrams of a GUI for editing a rule according to some of the example embodiments. Various aspects of screen diagram 700 have been described, and those elements bearing the same reference numerals as previously described elements are not repeated herein.

In an embodiment, screen diagram 700 illustrates the adding of rules to screen diagram 600 (or the editing of rules from an existing labor classification). In the illustrated embodiment, an average hourly rate of $20.00 was entered for a manager in text field 610.

Additionally, two rules (rule 702 and rule 704) were added for the manager classification. In rule 702, a metric of “sales” was selected via select box 706 from a list of available metrics. A user can assign a weighting via text box 708 and a type via options 710. In the illustrated embodiment, a “tier” option is selected via options 710 for rule 702. In a tier option, a plurality of tiers (e.g., tier 720, tier 722, tier 724) can be added to capture ranges of the underlying metric selected via select box 706. A user can further select a time increment via select box 712, which allows for varying the granularity of timeslots and thus predictions. As discussed, a given tier includes a minimum text box 714, maximum rate text box 716, and mapped labor demand 718. The minimum and maximum values define the range of the predicted metric, while the mapped labor demand assigns the desired labor demand to a given range. As discussed, screen diagram 600 can enforce that the ranges do not overlap or are inclusive of all possible values via an error or alert box (not illustrated) or a similar mechanism.

In the illustrated embodiment, rule 704 represents a multiplier rule as selected via select box 730. In a multiplier rule, a mapped labor demand can be defined for every increment of a metric. Thus, a user can enter the multiplier amount in text box 726 and mapped labor demand in text box 728. As a result, for rule 704, one worker will be mapped for each increment of five hundred swipes.

In an embodiment, a previous period simulation panel 606 includes a control 732 to simulate or re-simulate a demand prediction for a given set of rules in rules panel 604. In some embodiments, simulating the demand can comprise predicting the metric(s) defined in the rules panel 604 for a fixed period of time, applying the rules to the predicted metrics, and presenting the results in the previous period simulation panel 606. As illustrated, the previous period simulation panel 606 includes a cost panel 734 and hourly demand panel 736, which are similar to cost panel 508 and hourly demand panel 510, and that disclosure is not repeated herein. However, in contrast to cost panel 508 and hourly demand panel 510, the cost panel 734 only charts the manager classification (versus all classifications). Further, the hourly demand panel 736 only graphs the manager classification. In some embodiments, the use of a simulation and re-simulation allows a user to fine-tune the rules in previous period simulation panel 606 based on their desired outcomes. For example, a user may wish to limit a total weekly cost or a total number of hours and can thus manipulate the constraints in previous period simulation panel 606 to achieve this effect. Then, after adjusting the constraints, the rules can be run for future periods without manual intervention.

Finally, the screen diagram 700 can include a predicted demand panel 512, weekly demand graph 514, and work role demand graph 516. These panels are similar or identical to those discussed in FIGS. 5A and 5B and are not described again in detail herein.

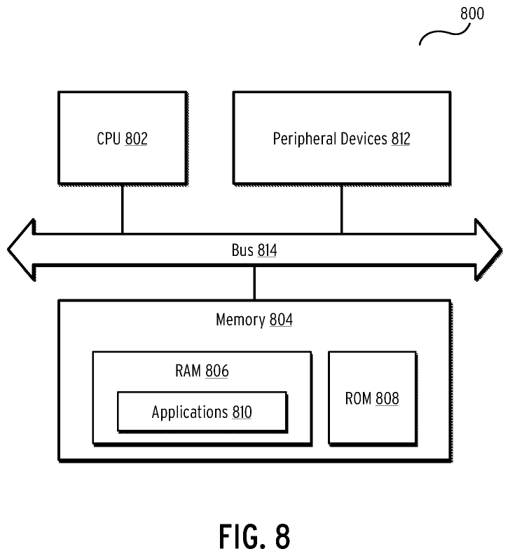

FIG. 8 is a block diagram of a computing device 800 according to some embodiments of the disclosure.

As illustrated, the device includes a processor or central processing unit (CPU) such as CPU 802 in communication with a memory 804 via a bus 814. The device also includes one or more input/output (I/O) or peripheral devices 812. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 802 may comprise a general-purpose CPU. The CPU 802 may comprise a single-core or multiple-core CPU. The CPU 802 may comprise a system-on-a-chip (SoC) or a similar embedded system. In some embodiments, a graphics processing unit (GPU) may be used in place of, or in combination with, a CPU 802. Memory 804 may comprise a non-transitory memory system including a dynamic random-access memory (DRAM), static random-access memory (SRAM), Flash (e.g., NAND Flash), or combinations thereof. In one embodiment, the bus 814 may comprise a Peripheral Component Interconnect Express (PCIe) bus. In some embodiments, bus 814 may comprise multiple busses instead of a single bus.

Memory 804 illustrates an example of non-transitory computer storage media for the storage of information such as computer-readable instructions, data structures, program modules, or other data. Memory 804 can store a basic input/output system (BIOS) in read-only memory (ROM), such as ROM 808, for controlling the low-level operation of the device. The memory can also store an operating system in random-access memory (RAM) for controlling the operation of the device

Applications 810 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 806 by CPU 802. CPU 802 may then read the software or data from RAM 806, process them, and store them in RAM 806 again.

The device may optionally communicate with a base station (not shown) or directly with another computing device. One or more network interfaces in peripheral devices 812 are sometimes referred to as a transceiver, transceiving device, or network interface card (NIC).

An audio interface in peripheral devices 812 produces and receives audio signals such as the sound of a human voice. For example, an audio interface may be coupled to a speaker and microphone (not shown) to enable telecommunication with others or generate an audio acknowledgment for some action. Displays in peripheral devices 812 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 812 may comprise any input device arranged to receive input from a user. An illuminator in peripheral devices 812 may provide a status indication or provide light. The device can also comprise an input/output interface in peripheral devices 812 for communication with external devices, using communication technologies, such as USB, infrared, Bluetooth™, or the like. A haptic interface in peripheral devices 812 provides tactile feedback to a user of the client device.

A GPS receiver in peripheral devices 812 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 8, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
generating, by a processor, a predicted metric for a future time period;
loading, by the processor, a plurality of rules, a given rule in the plurality of rules mapping an amount of the predicted metric to a demand amount;
applying, by the processor, the plurality of rules to the predicted metric to compute a set of demand amounts;
aggregating, by the processor, the set of demand amounts; and
generating, by the processor, a predicted demand based on the aggregated demand amounts.

2. The method of claim 1, wherein a given rule is associated with a labor classification, a given organization associated with at least one labor classification.

3. The method of claim 1, wherein a given rule in the plurality of rules is associated with a plurality of constraints.

4. The method of claim 3, wherein a given constraint in the plurality of constraints is associated with a range of amounts for the predicted metric and a demand amount.

5. The method of claim 3, wherein a given constraint in the plurality of constraints is associated with a multiplier of the predicted metric and a demand amount.

6. The method of claim 1, further comprising weighting each demand amount in the set of demand amounts prior to aggregating.

7. The method of claim 1, wherein the future time period comprises multiple timeslots and generating a predicted demand comprises generating a plurality of corresponding demands for each timeslot in the multiple timeslots.

8. A system comprising:
a processor; and
a storage medium for tangibly storing thereon program logic for execution by the processor, the program logic comprising:
logic, executed by the processor, for generating a predicted metric for a future time period;
logic, executed by the processor, for loading a plurality of rules, a given rule in the plurality of rules mapping an amount of the predicted metric to a demand amount;
logic, executed by the processor, for applying the plurality of rules to the predicted metric to compute a set of demand amounts;
logic, executed by the processor, for aggregating the set of demand amounts; and
logic, executed by the processor, for generating a predicted demand based on the aggregated demand amounts.

9. The system of claim 8, wherein a given rule is associated with a labor classification, a given organization associated with at least one labor classification.

10. The system of claim 8, wherein a given rule in the plurality of rules is associated with a plurality of constraints.

11. The system of claim 10, wherein a given constraint in the plurality of constraints is associated with a range of amounts for the predicted metric and a demand amount.

12. The system of claim 10, wherein a given constraint in the plurality of constraints is associated with a multiplier of the predicted metric and a demand amount.

13. The system of claim 8, the program logic further comprising logic, executed by the processor, for weighting each demand amount in the set of demand amounts prior to aggregating.

14. The system of claim 8, wherein the future time period comprises multiple timeslots and generating a predicted demand comprises generating a plurality of corresponding demands for each timeslot in the multiple timeslots.

15. A non-transitory computer-readable storage medium for tangibly storing computer program instructions capable of being executed by a computer processor, the computer program instructions defining steps of:
generating a predicted metric for a subsequent time period;
loading a rule mapping an amount of the predicted metric to a demand amount;
applying the rule to compute a demand amount; and
generating a predicted demand based on the demand amount.

16. The non-transitory computer-readable storage medium of claim 15, the rule is associated with a plurality of constraints.

17. The non-transitory computer-readable storage medium of claim 16, wherein a given constraint in the plurality of constraints is associated with a range of amounts for the predicted metric and a demand amount.

18. The non-transitory computer-readable storage medium of claim 16, wherein a given constraint in the plurality of constraints is associated with a multiplier of the predicted metric and a demand amount.

19. The non-transitory computer-readable storage medium of claim 15, further comprising weighting the demand amount.

20. The non-transitory computer-readable storage medium of claim 15, wherein the subsequent time period comprises multiple timeslots and generating a predicted demand comprises generating a plurality of corresponding demands for each timeslot in the multiple timeslots.
